(19) United States
(12) Patent Application Publication
(10) Pub. No.: US 2026/0064284 A1
(43) Pub. Date: Mar. 5, 2026

(54) MULTILEVEL INDEX AMORTIZATION IMPROVEMENT BY INTERMEDIATE LEVEL DYNAMIC SIZING

(71) Applicant: Dell Products L.P., Round Rock, TX (US)

(72) Inventors: Amit Zaitman, Shavey Shomron (IL); Uri Shabi, Tel Mond (IL); Alexander Shknevsky, Fair Lawn, NJ (US)

(21) Appl. No.: 18/825,205

(22) Filed: Sep. 5, 2024

(51) Int. Cl. G06F 3/06

(52) U.S. Cl. CPC G06F 3/0616; G06F 3/0641; G06F 3/0644; G06F 3/0685

(57) ABSTRACT

Techniques for improving amortization when hardening index entries across a multilevel hash table. The techniques include, in a first hardening cycle, in response to a first group of index entries filling a bucket at an in-memory hash table level L₁, hardening the bucket at L₁ to an initial bucket at an intermediate on-drive hash table level L₂. The techniques include, in subsequent successive hardening cycles, incrementally increasing the number of buckets at L₂ to a final number of buckets according to an arithmetic series, and, in response to a next group of index entries up to a last group of index entries filling the bucket at L₁, hardening the bucket at L₁ across the incrementally increased number of buckets at L₂. The techniques include, in response to the final number of buckets at L₂ being filled, hardening the buckets at L₂ across buckets at an on-drive hash table level L₃.

### BACKGROUND

Storage systems include storage processors coupled to arrays of storage drives, such as solid state drives (SSDs) and hard disk drives (HDDs). The storage processors receive and service storage input/output (IO) requests (e.g., write requests, read requests) from storage client computers (“storage clients”), which send the storage IO requests to the storage systems over a network. The storage IO requests specify datasets, such as data pages, data blocks, data files, or other data elements, to be written to or read from logical units (LUs), volumes (VOLs), filesystems, or other storage objects maintained on the storage drives. The storage systems perform data reduction processes, including data deduplication (“dedupe”) processes. The storage systems maintain dedupe indexes (e.g., hash tables) that associate content-based signatures or digests (e.g., hash values) of datasets with addresses associated with locations where the datasets are stored. The hash tables are maintained across several storage levels, including a volatile (“in-memory”) storage level, and a nonvolatile (“on-drive”) storage level. In response to the in-memory hash table level reaching a specified fullness threshold, dirty index entries (i.e., index entries not persisted to on-drive storage) are destaged (“hardened”) to the on-drive hash table level. The dirty index entries are merged with index entries at the on-drive hash table level, and deleted or removed from the in-memory hash table level. Having persisted the dirty index entries to the on-drive hash table level, the index entries are marked as being clean.

### SUMMARY

In storage systems, it is desirable to amortize write operations to on-drive storage, as such write operations can be considered expensive not only in terms of drive wear, but also in terms of time and/or other storage resources required to complete the write operations. The term “amortization” in this context refers to distributing the cost of metadata storage operations (e.g., updating file system structures or indexes on drives) over a series of user data storage operations (e.g., writing actual user data to drives). This process aims to balance the frequency and impact of metadata writes with the volume of user data writes, optimizing overall system performance and drive longevity. To improve amortization when hardening dirty index entries, storage systems can implement a series of hash table levels of increasing size. As employed herein, the term “hardening” generally refers to writing data (e.g., index entries) from an in-memory hash table level to an on-drive hash table level, or writing index entries from one on-drive hash table level to another on-drive hash table level. In one embodiment, each in-memory and on-drive hash table level can include one or more bucket data structures (“buckets”), in which each bucket can accommodate a maximum number of index entries (e.g., 256) rounded to the closest native page size (e.g., 4 kilobytes (KB)).

To demonstrate how implementing a series of hash table levels can improve amortization, consider first the case where dirty index entries (“new entries”) at the in-memory hash table level (designated as “L₁”) are hardened to the on-drive hash table level (designated as “L₃”). In this case, the in-memory hash table level L₁ can include a single bucket, and the on-drive hash table level L₃ can include a plurality of buckets (e.g., 256). As such, the size of the on-drive hash table level L₃ can be two hundred fifty-six (256) times larger than the size of the in-memory hash table level L₁. In response to the single bucket at L₁ reaching a specified fullness threshold (e.g., 256 new entries), the new entries can be hardened across the 256 buckets at L₃. Taking the ratio of the number of new entries (“#NewEntries”) (e.g., 256) to the number of required write operations to the buckets at L₃ (“#L3Writes”) (e.g., 256), the amortization for hardening the new entries can be determined, as follows:

$$Amortization = \frac{♯ N e w E n t r i e s}{♯ {L}_{3} W r i t e s} = \frac{256}{256} = 1$$

Consider now the case where new entries at the in-memory hash table level L₁ are first hardened to an intermediate on-drive hash table level (designated as “L₂”), and subsequently hardened to the on-drive hash table level L₃. In this case, the in-memory hash table level L₁ can include the single bucket, the intermediate on-drive hash table level L₂ can include a plurality of buckets (e.g., 16), and the on-drive hash table level L₃ can include the increased plurality of buckets (e.g., 256). As such, the size of the intermediate on-drive hash table level L₂ can be sixteen (16) times larger than the size of the in-memory hash table level L₁, and the size of the on-drive hash table level L₃ can be 16 times larger than the size of the intermediate on-drive hash table level L₂ (or 256 times larger than the size of the in-memory hash table level L₁). In response to the single bucket at L₁ reaching the specified fullness threshold (e.g., 256 new entries), the new entries can be hardened across the 16 buckets at L₂, requiring 16 write operations to the buckets at L₂. Because the 16 write operations can cause 16 new entries to be written to each bucket at L₂, the hardening of new entries contained in the single bucket at L₁ can be repeated 16 times to fill the 16 buckets at L₂ to their total capacities (e.g., 256 index entries). As a result, the number of new entries hardened to the 16 buckets at L₂ (“#NewEntries”) can be equal to 16*256 or 4,096, and the number of required write operations to the 16 buckets at L₂ (“#L2Writes”) can be equal to 16*16 or 256. Taking the ratio of #NewEntries (e.g., 4,096) to the sum of #L2Writes (e.g., 256) and #L3Writes (e.g., 256), an improved amortization for hardening the new entries can be determined, as follows:

$$Amortization = \frac{♯ N e w E n t r i e s}{♯ {L}_{2} W r i t e s + ♯ {L}_{3} Writes} = \frac{4 , 096}{256 + 256} = \frac{4 , 096}{512} = 8$$

Techniques are disclosed herein for providing improvements in amortization when hardening index entries across a series of hash table levels. The disclosed techniques can include, in a storage system, an in-memory hash table level L₁, an on-drive hash table level L₃, and an intermediate on-drive hash table level L₂ between L₁ and L₃. The in-memory and on-drive hash table levels L₁ and L₃ can have sizes defined by predetermined numbers of buckets. In one embodiment, L₁ can have a size defined by a single bucket, and L₃ can have a size defined by 256 buckets. Further, L₂ can have a size that is dynamically expandable in successive cycles for hardening new entries. Each bucket at L₁, L₂, and L₃ can accommodate a maximum number of index entries (e.g., 256) rounded to the closest native page size (e.g., 4 kilobytes (KB)). In one embodiment, the intermediate on-drive hash table level L₂ can have an initial size equal to the size of the in-memory hash table level L₁ (e.g., 1 bucket). Further, in successive hardening cycles from L₁ to L₂, the size of the intermediate on-drive hash table level L₂ can be dynamically expanded according to an arithmetic series, from the initial size (e.g., 1 bucket) to a final size, at which point all buckets at L₂ can be filled to the maximum number of index entries (e.g., 256). It is noted that after the index entries at the intermediate on-drive hash table level L₂ are hardened to the on-drive hash table level L₃, the size of the intermediate on-drive hash table level L₂ can be reset from the final size to the initial size (e.g., 1 bucket).

As will be described herein in subsequent sections, the disclosed techniques can allow the final size of the intermediate on-drive hash table level L₂ to be increased by an approximate factor of \sqrt{2} compared to prior techniques. In one embodiment, the final size of the intermediate on-drive hash table level L₂ can be increased from 16 buckets to twenty-two (22) buckets. As such, based on the sum of an arithmetic series, the number of required write operations to the 22 buckets at L₂ (“#L2Writes”) can be determined, as follows:

$$\frac{S ( S + 1 )}{2} = \frac{22 ( 22 + 1 )}{2} = 253$$

In addition, the number of new entries hardened to the 22 buckets at L₂ (“#NewEntries”) can be equal to 22*256 or 5,632. Taking the ratio of #NewEntries (e.g., 5,632) to the sum of #L2Writes (e.g., 253) and #L3Writes (e.g., 256), an improved amortization for hardening the new entries can be determined, as follows:

$$Amortization = \frac{♯ N e w E n t r i e s}{♯ {L}_{2} W r i t e s + ♯ {L}_{3} Writes} = \frac{5 , 632}{253 + 256} = \frac{5 , 632}{509} ≅ 11$$

As can be seen from the foregoing, the disclosed techniques for improving amortization in multilevel hash tables not only allow for an increase in the final size of the intermediate on-drive hash table level L₂, but also a reduction in the number of required write operations to the intermediate on-drive hash table level L₂. Indeed, as will be described herein in subsequent sections, in the limit where the ratio of the size of L₂ to the size of L approaches infinity, the number of required write operations to the intermediate on-drive hash table level L₂ can be reduced by half in comparison to prior techniques. Moreover, the increased final size of the intermediate on-drive hash table level L₂ can allow for better aggregation of index entries before hardening to the on-drive hash table level L₃, further contributing to improved amortization.

The disclosed techniques can include providing or making accessible a multilevel hash table that encompasses an in-memory hash table level L₁, an on-drive hash table level L₃, and an intermediate on-drive hash table level L₂ between L₁ and L₃. Each of L₁, L₂, and L₃ can include one or more buckets, in which each bucket has a total capacity for storing a maximum number of index entries. The in-memory hash table level L₁ can include a single bucket. The intermediate on-drive hash table level L₂ can include a number of buckets ranging from an initial number of buckets to a final number of buckets, in which the initial number corresponds to a single initial bucket. The on-drive hash table level L₃ can include a predetermined number of buckets greater than the final number of buckets at the intermediate on-drive hash table level L₂. The disclosed techniques can include, in a first hardening cycle, in response to a first group of index entries filling the total capacity of the single bucket at L₁, hardening the single bucket at L₁ to the single initial bucket at L₂. The disclosed techniques can include, in subsequent successive hardening cycles, incrementally increasing the number of buckets at L₂ from the initial number of buckets to the final number of buckets according to an arithmetic series, and, in response to a next group of index entries up to a last group of index entries filling the total capacity of the single bucket at L₁, hardening the single bucket at L₁ across the incrementally increased number of buckets at L₂ until the total capacities of the final number of buckets at L₂ are filled. The disclosed techniques can include, in response to the total capacities of the final number of buckets at L₂ being filled, hardening the final number of buckets at L₂ across the predetermined number of buckets at L₃.

In certain embodiments, a method includes, in a first hardening cycle, in response to a first group of index entries filling a single bucket data structure (“bucket”) at an in-memory hash table level (“L₁”), hardening the single bucket at L₁ to a single initial bucket at an intermediate on-drive hash table level (“L₂”). The method includes, in subsequent successive hardening cycles, incrementally increasing a number of buckets at L₂ to a final number of buckets according to an arithmetic series, and in response to a next group of index entries up to a last group of index entries filling the single bucket at L₁, hardening the single bucket at L₁ across the incrementally increased number of buckets at L₂. The method includes, in response to the final number of buckets at L₂ being filled with index entries, hardening the final number of buckets at L₂ across a predetermined number of buckets at an on-drive hash table level (“L₃”). The predetermined number of buckets at L₃ is greater than the final number of buckets at L₂.

In certain arrangements, the method includes, in the first hardening cycle, having hardened the single bucket at L₁ to the single initial bucket at L₂, deleting or removing the first group of index entries from the single bucket at L₁.

In certain arrangements, the method includes, in the subsequent successive hardening cycles, having hardened the single bucket at L₁ across the incrementally increased number of buckets at L₂, deleting or removing the next group of index entries up to the last group of index entries from the single bucket at L₁.

In certain arrangements, the method includes, having hardened the final number of buckets at L₂ across the predetermined number of buckets at L₃, resetting the number of buckets at L₂ to an initial number defined by a single bucket.

In certain arrangements, “|L₁|” denotes a size of L₁ in terms of a first number of buckets, “|L₂|” denotes a size of L₂ in terms of the final number of buckets, and “|L₃|” denotes a size of L₃ in terms of the predetermined number of buckets. The method includes incrementally increasing the size of L₂ to |L₂| expressed as:

$$\vert {L}_{2} \vert = \sqrt{2 \vert {L}_{1} \vert \vert {L}_{3} \vert}$$

In certain arrangements, “R₂” denotes a ratio of |L₂| to |L₁|, “R₃” denotes a ratio of |L₃| to |L₁|, and “B” denotes a fullness threshold for each bucket at L₁, L₂, and L₃ in terms of a predetermined number of index entries. The method includes determining an amortization for hardening the final number of buckets at L₂ across the predetermined number of buckets at L₃, in which the amortization is expressed as:

$$Amortization = \frac{2 {R}_{2} * B}{{R}_{2}^{2} + {R}_{2} + 2 {R}_{3}}$$

In certain arrangements, the method includes incrementally increasing the number of buckets at L₂ to the final number of buckets according to the arithmetic series expressed as:

$${\sum }_{k = 1}^{{R}_{2}} k = 1 + 2 + 3 + … + {R}_{2} = \frac{{R}_{2} ( {R}_{2} + 1 )}{2} = \frac{{R}_{2}^{2} + {R}_{2}}{2}$$

In certain embodiments, a system includes a memory, and processing circuitry configured to execute program instructions out of the memory, in a first hardening cycle, in response to a first group of index entries filling a single bucket data structure (“bucket”) at an in-memory hash table level (“L₁”), to harden the single bucket at L₁ to a single initial bucket at an intermediate on-drive hash table level (“L₂”). The processing circuitry is configured to execute the program instructions out of the memory, in subsequent successive hardening cycles, to incrementally increase a number of buckets at L₂ to a final number of buckets according to an arithmetic series, and, in response to a next group of index entries up to a last group of index entries filling the single bucket at L₁, harden the single bucket at L₁ across the incrementally increased number of buckets at L₂. The processing circuitry is configured to execute the program instructions out of the memory, in response to the final number of buckets at L₂ being filled with index entries, harden the final number of buckets at L₂ across a predetermined number of buckets at an on-drive hash table level (“L₃”). The predetermined number of buckets at L₃ is greater than the final number of buckets at L₂.

In certain arrangements, the processing circuitry is configured to execute the program instructions out of the memory, in the first hardening cycle, having hardened the single bucket at L₁ to the single initial bucket at L₂, to delete or remove the first group of index entries from the single bucket at L₁.

In certain arrangements, the processing circuitry is configured to execute the program instructions out of the memory, in the subsequent successive hardening cycles, having hardened the single bucket at L₁ across the incrementally increased number of buckets at L₂, to delete or remove the next group of index entries up to the last group of index entries from the single bucket at L₁.

In certain arrangements, the processing circuitry is configured to execute the program instructions out of the memory, having hardened the final number of buckets at L₂ across the predetermined number of buckets at L₃, to reset the number of buckets at L₂ to an initial number defined by a single bucket.

In certain arrangements, “|L₁|” denotes a size of L₁ in terms of a first number of buckets, “|L₂|” denotes a size of L₂ in terms of the final number of buckets, and “|L₃|” denotes a size of L₃ in terms of the predetermined number of buckets. The processing circuitry is configured to execute the program instructions out of the memory to incrementally increase the size of L₂ to |L₂| expressed as:

$$\vert {L}_{2} \vert = \sqrt{2 \vert {L}_{1} \vert \vert {L}_{3} \vert}$$

In certain arrangements, “R₂” denotes a ratio of |L₂| to |L₁|, “R₃” denotes a ratio of |L₃| to |L₁|, and “B” denotes a fullness threshold for each bucket at L₁, L₂, and L₃ in terms of a predetermined number of index entries. The processing circuitry is configured to execute the program instructions out of the memory to determine an amortization for hardening the final number of buckets at L₂ across the predetermined number of buckets at L₃, in which the amortization is expressed as:

$$Amortization = \frac{2 {R}_{2} * B}{{R}_{2}^{2} + {R}_{2} + 2 {R}_{3}}$$

In certain arrangements, the processing circuitry is configured to execute the program instructions out of the memory to incrementally increase the number of buckets at L₂ to the final number of buckets according to the arithmetic series expressed as:

$${\sum }_{k = 1}^{{R}_{2}} k = 1 + 2 + 3 + … + {R}_{2} = \frac{{R}_{2} ( {R}_{2} + 1 )}{2} = \frac{{R}_{2}^{2} + {R}_{2}}{2}$$

In certain embodiments, a computer program product includes a set of non-transitory, computer-readable media having program instructions that, when executed by processing circuitry, cause the processing circuitry to perform a method including, in a first hardening cycle, in response to a first group of index entries filling a single bucket data structure (“bucket”) at an in-memory hash table level (“L₁”), hardening the single bucket at L₁ to a single initial bucket at an intermediate on-drive hash table level (“L₂”). The method includes, in subsequent successive hardening cycles, incrementally increasing a number of buckets at L₂ to a final number of buckets according to an arithmetic series, and in response to a next group of index entries up to a last group of index entries filling the single bucket at L₁, hardening the single bucket at L₁ across the incrementally increased number of buckets at L₂. The method includes, in response to the final number of buckets at L₂ being filled with index entries, hardening the final number of buckets at L₂ across a predetermined number of buckets at an on-drive hash table level (“L₃”). The predetermined number of buckets at L₃ is greater than the final number of buckets at L₂.

Other features, functions, and aspects of the present disclosure will be evident from the Detailed Description that follows.

### BRIEF DESCRIPTION OF THE DRAWINGS

The foregoing and other objects, features, and advantages will be apparent from the following description of particular embodiments of the present disclosure, as illustrated in the accompanying drawings, in which like reference characters refer to the same parts throughout the different views.

FIG. 1 is a block diagram of an exemplary storage environment, in which techniques can be practiced for improving amortization when hardening index entries across a series of hash table levels;

FIG. 2 is a block diagram of an exemplary namespace layer, an exemplary mapping layer, an exemplary virtualization layer, and an exemplary physical layer, each of which can be implemented in the storage environment of FIG. 1;

FIG. 3 is a diagram of an exemplary on-drive hash table that can be implemented in the storage environment of FIG. 1, in which index entries are assigned to a plurality of bucket data structures (“buckets”);

FIG. 4 is a block diagram of a prior technique for hardening index entries across a series of hash table levels;

FIGS. 5a-5d are block diagrams of an exemplary technique for hardening index entries across a series of hash table levels that can be practiced in the storage environment of FIG. 1, in which the hash table levels include an in-memory hash table level L₁, an on-drive hash table level L₃, and an intermediate hash table level L₂ between L₁ and L₃;

FIG. 6 is a diagram of exemplary percentage (%) improvements in amortization, which can be achieved when hardening index entries using the technique of FIGS. 5a-5d; and

FIG. 7 is a flow diagram of an exemplary method of hardening index entries across a series of hash table levels.

### DETAILED DESCRIPTION

Techniques are disclosed herein for improving amortization when hardening index entries across a series of hash table levels. The disclosed techniques can include providing or making accessible a multilevel hash table that encompasses an in-memory hash table level L₁, an on-drive hash table level L₃, and an intermediate on-drive hash table level L₂ between L₁ and L₃. The disclosed techniques can include, in a first hardening cycle, in response to a first group of index entries filling a total capacity of a single bucket at L₁, hardening the single bucket at L₁ to a single initial bucket at L₂. The disclosed techniques can include, in subsequent successive hardening cycles, incrementally increasing the number of buckets at L₂ from an initial number of buckets to a final number of buckets according to an arithmetic series, and, in response to a next group of index entries up to a last group of index entries filling the total capacity of the single bucket at L₁, hardening the single bucket at L₁ across the incrementally increased number of buckets at L₂ until total capacities of the final number of buckets at L₂ are filled. The disclosed techniques can include, in response to the total capacities of the final number of buckets at L₂ being filled, hardening the final number of buckets at L₂ across an increased number of buckets at L₃. The disclosed techniques can allow for an increase in the final size of the intermediate on-drive hash table level L₂, as well as a reduction in the number of required write operations to the intermediate on-drive hash table level L₂, both of which can contribute to improved amortization.

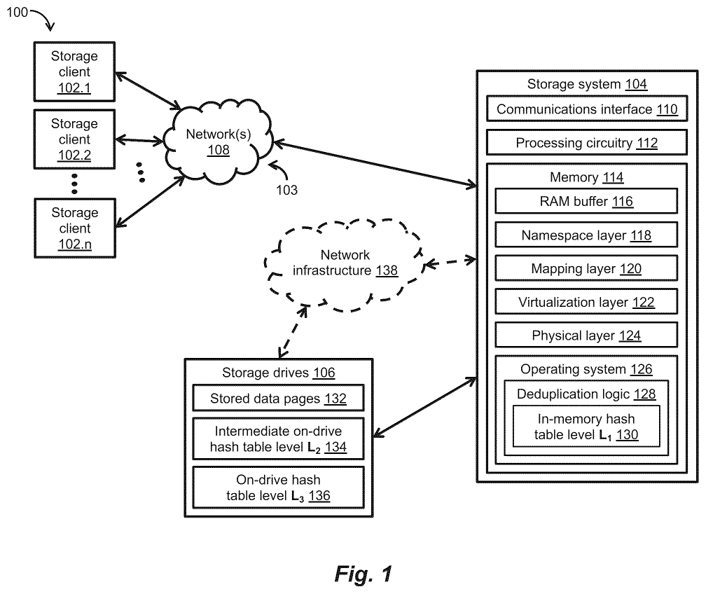

FIG. 1 depicts an illustrative embodiment of an exemplary storage environment 100 for improving amortization when hardening index entries across a series of hash table levels. As shown in FIG. 1, the storage environment 100 can include a plurality of storage client computers (“storage clients”) 102.1, 102.2, . . . , 102.n, a storage system 104, storage drives 106, and a communications medium 103 that includes at least one network 108. Each storage client 102.1, . . . , 102.n can provide, over the network(s) 108, storage input/output (IO) requests (e.g., small computer system interface (SCSI) commands, network file system (NFS) commands) to the storage system 104. Such storage IO requests (e.g., write requests, read requests) can direct the storage system 104 to write and/or read datasets including data pages, data blocks, data files, or any other suitable data elements, to/from logical units (LUs), volumes (VOLs), virtual volumes (VVOLs) (e.g., VMware® VVOLs), filesystems, or any other suitable storage objects, maintained on the storage drives (e.g., solid state drives (SSDs), flash drives, hard disk drives (HDDs)) 106.

The communications medium 103 can be configured to interconnect the plurality of storage clients 102.1, . . . , 102.n with the storage system 104, enabling them to communicate and exchange data and control signaling. As shown in FIG. 1, the communications medium 103 can be illustrated as a “cloud” to represent different network topologies, such as a storage area network (SAN) topology, a network attached storage (NAS) topology, a local area network (LAN) topology, a metropolitan area network (MAN) topology, a wide area network (WAN) topology, and so on. As such, the communications medium 103 can include copper-based communications devices and cabling, fiber optic devices and cabling, wireless devices, and so on, or any suitable combination thereof.

The storage system 104 can be connected either directly to the storage drives 106, or indirectly through an optional network infrastructure 138. The network infrastructure 138 can include an Ethernet network, an InfiniBand network, a Fiber Channel (FC) network, or any other suitable network. As shown in FIG. 1, the storage system 104 can include a communications interface 110, processing circuitry 112, and a memory 114. The communications interface 110 can include an Ethernet interface, an InfiniBand interface, an FC interface, or any other suitable communications interface. The communications interface 110 can further include SCSI target adapters, network interface adapters, or any other suitable adapters, for converting electronic, optical, or wireless signals received over the network(s) 108 to a form suitable for use by the processing circuitry 112. The processing circuitry 112 (e.g., central processing unit (CPU)) can include a set of processing cores (e.g., CPU cores) configured to execute specialized code, modules, and/or logic as program instructions out of the memory 114, process storage IO requests (e.g., write requests, read requests) issued by the storage clients 102.1, . . . , 102.n, and store datasets (e.g., data pages) on the storage drives 106 within the storage environment 100, which can be a RAID (Redundant Array of Independent Disks) environment.

The memory 114 can include volatile memory, such as random access memory (RAM), a RAM buffer 116, and/or any other suitable volatile memory, as well as nonvolatile memory, such as nonvolatile RAM (NVRAM), and/or any other suitable nonvolatile memory. The memory 114 can accommodate a variety of specialized software constructs, including a namespace layer 118, a mapping layer 120, a virtualization layer 122, and a physical layer 124. The memory 114 can also accommodate an operating system (OS) 126, such as a Linux OS, Unix OS, Windows OS, or any other suitable OS, as well as specialized software code, modules, and/or logic, including deduplication (“dedupe”) logic 128. The dedupe logic 128 can operate on received data pages in association with an in-memory hash table level L₁ 130. The storage drives 106 can maintain stored data pages 132, an intermediate on-drive hash table level L₂ 134, and an on-drive hash table level L₃ 136, on one or more of the storage drives (e.g., SSDs, HDDs) 106.

The namespace layer 118 can be configured as a logical structure for organizing storage objects, such as LUs, VOLs, VVOLs, filesystems, or any other suitable storage objects. The namespace layer 118 can track logical addresses of the storage objects, including offsets into LUs or file system addresses. In one embodiment, if an LU has a maximum size of 10 gigabytes (GB), then the namespace layer 118 can provide a 10 GB logical address range to accommodate the LU. The mapping layer 120 can be configured as a logical structure for mapping the logical addresses of storage objects in the namespace layer 118 to virtual data structures in the virtualization layer 122. The mapping layer 120 can include a plurality of pointer arrays arranged as multi-level tree data structures (e.g., b-trees), a lowest level of which can include a plurality of leaf pointers.

The virtualization layer 122 can be configured as a logical structure for providing page virtualization in support of data deduplication. The virtualization layer 122 can include an aggregation of virtual large blocks (VLBs), each of which can include a plurality of virtual data structures. Each virtual data structure can contain virtual descriptor information, such as an address (“virtual address”) configured to point to a location of a dataset (e.g., data page) in the physical layer 124, a reference count (“Ref_count”) for keeping track of a number of leaf pointers that point to the virtual data structure, digest (e.g., hash) information, and so on. The physical layer 124 can be configured as a logical structure for storing an aggregation of physical large blocks (PLBs), each of which can accommodate a plurality of compressed or uncompressed datasets (e.g., data pages). Each virtual address can point to a data page in a PLB of the physical layer 124. It is noted that, although the physical layer 124 is described herein using the term “physical”, an underlying storage drive is responsible for the actual physical storage of storage client data.

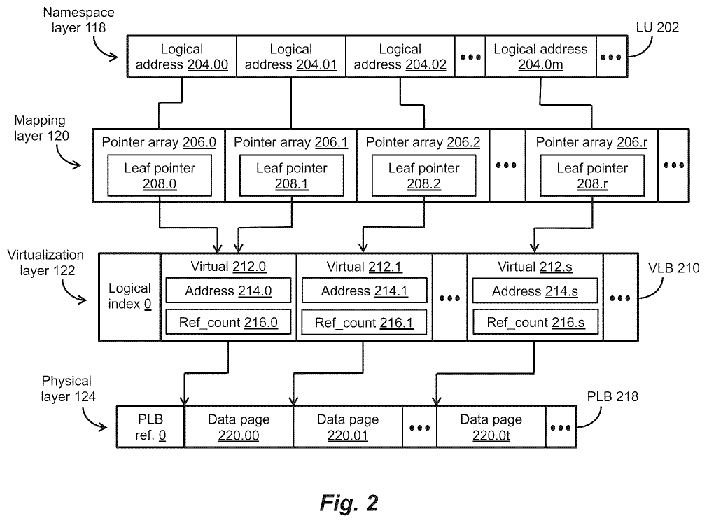

FIG. 2 depicts portions of the namespace layer 118 and the physical layer 124, as well as multiple layers of indirection provided by the mapping layer 120 and the virtualization layer 122. As shown in FIG. 2, the namespace layer 118 can include an LU 202, which can have a logical address 204.00, a logical address 204.01, a logical address 204.02, and so on, up to at least a logical address 204.0m, associated therewith. For example, the logical addresses 204.00, 204.01, . . . , 204.0m, . . . may correspond to contiguous offsets into the LU 202. The virtualization layer 122 can include a VLB 210, which can be associated with a logical index “0”. The VLB 210 can include a virtual data structure (“virtual”) 212.0, a virtual 212.1, and so on, up to at least a virtual 212.s. The mapping layer 120 can include a pointer array 206.0, a pointer array 206.1, a pointer array 206.2, and so on, up to at least a pointer array 206.r. The pointer array 206.0 can include a leaf pointer 208.0, the pointer array 206.1 can include a leaf pointer 208.1, the pointer array 206.2 can include a leaf pointer 208.2, and so on, up to at least the pointer array 206.r, which can include a leaf pointer 208.r. The mapping layer 120 can map the logical addresses 204.00, . . . , 204.0m, . . . of the LU 202 to the virtuals 212.0, . . . , 212.s, . . . of the VLB 210. For example, the leaf pointer 208.0 and the leaf pointer 208.1 may each point to the virtual 212.0, the leaf pointer 208.2 may point to the virtual 212.1, and so on, up to at least the leaf pointer 208.r, which may point to the virtual 212.s. The physical layer 124 can include a PLB 218, which can be associated with a PLB reference (“PLB ref.”) “0”. The PLB 218 can include a data page 220.00, a data page 220.01, and so on, up to at least a data page 220.0t.

To support data deduplication, the virtual 212.0 can contain virtual descriptor information, including an address (“virtual address”) 214.0, and a reference count (“Ref_count”) 216.0 that keeps track of the number of leaf pointers pointing to the virtual 212.0. As shown in FIG. 2, the virtual address 214.0 can be configured to point to a location of the data page 220.00 in the PLB 218. Further, because the two (2) leaf pointers 208.0, 208.1 point to the same virtual 212.0, the Ref_count 216.0 can be equal to “2”. Likewise, the virtual 212.1 can contain virtual descriptor information, including an address (“virtual address”) 214.1, and a reference count (“Ref_count”) 216.1 that keeps track of the number of leaf pointers pointing to the virtual 212.1. As shown in FIG. 2, the virtual address 214.1 can be configured to point to a location of the data page 220.01 in the PLB 218. Further, because only the leaf pointer 208.2 points to the virtual 212.1, the Ref_count 216.1 can be equal to “1”. In addition, the virtual 212.s can contain virtual descriptor information, including an address (“virtual address”) 214.s, and a reference count (“Ref_count”) 216.s that keeps track of the number of leaf pointers pointing to the virtual 212.s. As shown in FIG. 2d, the virtual address 212.s can be configured to point to a location of the data page 220.0t in the PLB 218. Further, because only the leaf pointer 208.r points to the virtual 212.s, the Ref_count 216.s can be equal to “1”.

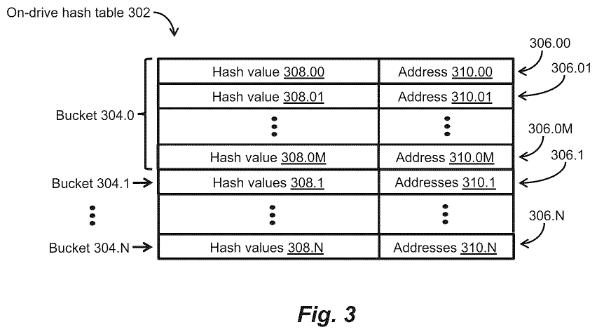

FIG. 3 depicts an exemplary on-drive hash table 302. As shown in FIG. 3, the on-drive hash table 302 can include a plurality of index entries, each of which can include a content-based signature or digest (e.g., hash value; SHA-1) of a stored data page, and an address (e.g., virtual address) associated with a location where the data page is stored. In one embodiment, each index entry can be implemented as a key-value pair (e.g., <hash value, virtual address>). For example, an index entry 306.00 may include a hash value 308.00 of a data page, and a virtual address 310.00 associated with a location where the data page is stored; an index entry 306.01 may include a hash value 308.01 of a data page, and a virtual address 310.01 associated with a location where the data page is stored; and so on, up to and including an index entry 306.0M, which may include a hash value 308.0M of a data page, and a virtual address 310.0M associated with a location where the data page is stored. Likewise, index entries 306.1 may include hash values 308.1 of data pages, and virtual addresses 310.1 associated with locations where the data pages are stored, and so on, up to and including index entries 306.N, which may include hash values 308.N of data pages, and virtual addresses 310.N associated with locations where the data pages are stored. The plurality of index entries 306.00-306.0M, 306.1, . . . , 306.N can be assigned to a plurality of bucket data structures (“buckets”) 304.0, 304.1, . . . , 304.N. For example, the index entries 306.00, 306.01, . . . , 306.0M may be assigned to the bucket 304.0, the index entries 306.1 may be assigned to the bucket 304.1, and so on, up to and including the index entries 306.N, which may be assigned to the bucket 304.N. It is noted that each of the intermediate on-drive hash table level L₂ 134 and the on-drive hash table level L₁ 136 can be implemented like the on-drive hash table 302. It is further noted that the in-memory hash table level L₁ 130 can include, in a single bucket, index entries including hash values of data pages, and virtual addresses associated with locations where the data pages are stored.

During operation, the storage system 104 can execute the dedupe logic 128 to provide or make accessible a multilevel hash table that encompasses an in-memory hash table level L₁, an on-drive hash table level L₃, and an intermediate on-drive hash table level L₂ between L₁ and L₃. Each of L₁, L₂, and L₃ can include one or more buckets, in which each bucket can have a total capacity for storing a maximum number of index entries rounded to the closest native page size (e.g., 4 kilobytes (KB)). The in-memory hash table level Lⱼ can include a single bucket. The intermediate on-drive hash table level L₂ can include a number of buckets ranging from an initial number of buckets to a final number of buckets. For example, the initial number of buckets at L₂ can correspond to a single initial bucket. The on-drive hash table level L₃ can include a predetermined number of buckets greater than the final number of buckets at the intermediate hash table level L₂. The dedupe logic 128 can be executed, in a first hardening cycle, in response to a first group of index entries filling the total capacity of the single bucket at L₁, to harden the single bucket at L₁ to the single initial bucket at L₂. The dedupe logic 128 can be executed, in subsequent successive hardening cycles, to incrementally increase the number of buckets at L₂ from the initial number of buckets to the final number of buckets according to an arithmetic series, and, in response to a next group of index entries up to a last group of index entries filling the total capacity of the single bucket at L₁, to harden the single bucket at L₁ across the incrementally increased number of buckets at L₂ until the total capacities of the final number of buckets at L₂ are filled. The dedupe logic 128 can be executed, in response to the final number of buckets at L₂ being filled, to harden the final number of buckets at L₂ across the predetermined number of buckets at L₃.

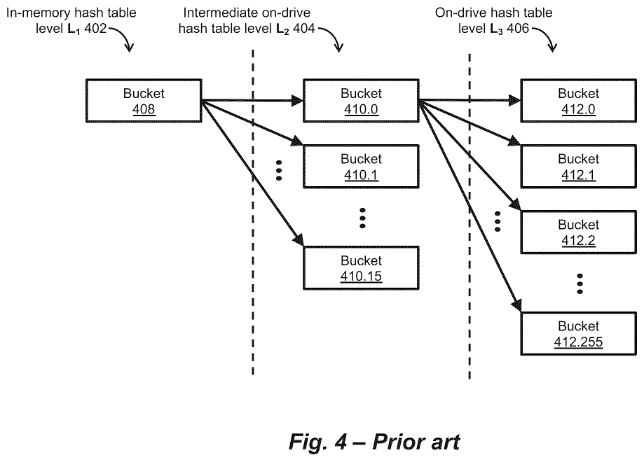

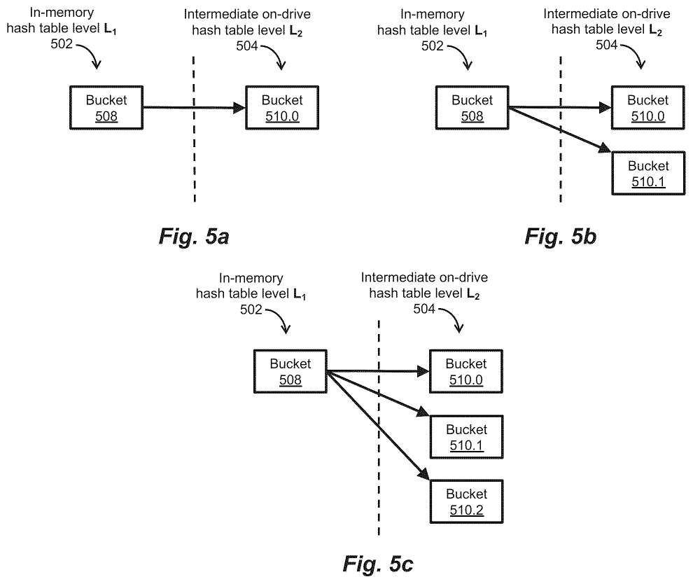

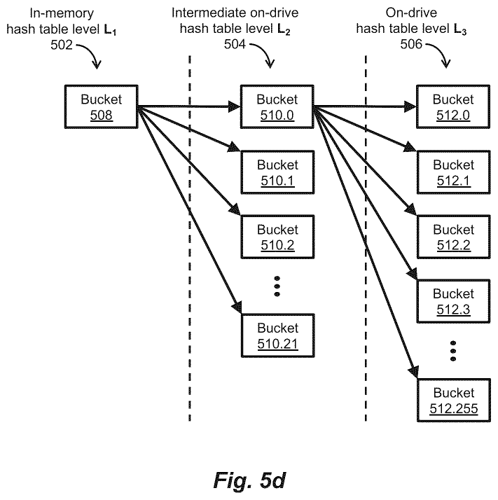

The disclosed techniques for providing improved amortization when hardening index entries across a series of hash table levels will be further understood with reference to the following illustrative examples and FIGS. 4 and 5a-5d. In a first example, a prior technique is described that involves a multilevel hash table encompassing an in-memory hash table level L₁ 402, an on-drive hash table level L₃ 406, and an intermediate on-drive hash table level L₂ 404 between L₁ 402 and L₃ 406 (see FIG. 4).

FIG. 4 depicts the in-memory hash table level L₁ 402, the intermediate on-drive hash table level L₂ 404, and the on-drive hash table level L₃ 406. In this first example, each hash table level L₁, 402, L₂ 404, L₃ 406 has a size defined by a fixed number of buckets. As shown in FIG. 4, the in-memory hash table level L₁ 402 has a size defined by a single bucket 408, the intermediate on-drive hash table level L₂ 404 has a size defined by sixteen (16) buckets 410.0, 410.1, . . . , 410.15, and the on-drive hash table level L₃ 406 has a size defined by two hundred fifty-six buckets (256) 412.0, 412.1, 412.2, . . . , 412.255. As such, the size of the intermediate on-drive hash table level L₂ 404 is 16 times larger than the size of the in-memory hash table level L₁ 402, and the size of the on-drive hash table level L₃ 406 is 16 times larger than the size of the intermediate on-drive hash table level L₂ 404 (or 256 times larger than the size of the in-memory hash table level L₁ 402). The in-memory hash table level L₁ 402 is maintained in “fast” memory (e.g., RAM), and functions as a cache for the most frequently accessed (or most recently used) index entries. Further, the intermediate on-drive hash table level L₂ 404 is maintained on a storage drive (e.g., SSD), and functions as a buffer between the hash table levels L₁ 402, L₃ 406, accumulating or aggregating index entries from the in-memory hash table level L₁ 402 before hardening the index entries to the on-drive hash table level L₃ 406. Likewise, the on-drive hash table level L₃ 406 is maintained on a storage drive (e.g., SSD), and configured to accommodate the bulk of index entries for the multi-level hash table. For example, the on-drive hash table level L₃ 406 may be accessed if a requested index entry is not found in either the in-memory hash table level L₁ 402 or the intermediate on-drive hash table level L₂ 404.

In these illustrative examples, the following definitions are employed:

$$\vert {L}_{x} \vert = Size of hash table level {L}_{x} in terms of number of buckets , \qquad ( 1 )$$

$${R}_{x} = \frac{\vert {L}_{x} \vert}{\vert {L}_{1} \vert} , where x = 1 , 2 , or 3 , and \qquad ( 2 )$$

$$B = Fullness threshold for bucket in terms of index entries . \qquad ( 3 )$$

As described herein, the in-memory hash table level L₁ 402 has a size, |L₁|, defined by a single or one (1) bucket, the intermediate on-drive hash table level L₂ 404 has a size, |L₂, defined by 16 buckets, and the on-drive hash table level L₃ 406 has a size, |L₃|, defined by 256 buckets. Further, a fullness threshold, B, for each bucket at each hash table level L₁, 402, L₂ 404, L₃ 406 is specified as 256 index entries (rounded to the closest native page size (e.g., 4 KB)). Accordingly, R₂, R₃, and B can be determined, as follows:

$${R}_{2} = \frac{\vert {L}_{2} \vert}{\vert {L}_{1} \vert} = \frac{16}{1} = 16 \qquad ( 4 )$$

$${R}_{3} = \frac{\vert {L}_{3} \vert}{\vert {L}_{1} \vert} = \frac{256}{1} = 256 \qquad ( 5 )$$

$$B = 25 \; 6 \qquad ( 6 )$$

In response to the bucket 408 at L₁ 402 reaching the specified fullness threshold, B (i.e., 256 index entries; see equation (6)), new index entries contained in the bucket 408 are hardened across the buckets 410.0, . . . , 410.15 at L₂ 404, thereby requiring 16 write operations to the buckets 410.0, . . . , 410.15. In this first example, each bucket at L₂ 404 and L₃ 406 has a corresponding bucket number. As such, when hardening new entries contained in the bucket 408 at L₁ 402 across the buckets 410.0, . . . , 410.15 at L₂ 404, each new entry that includes a hash value, H, can be mapped to the bucket 410.0, . . . , or 410.15 having a corresponding bucket number, N. For example, the mapping of new entries between hash table levels may be based on a hash value, H, the size, |Lₓ|(x=2, 3), of the hash table level to which the new entries are being mapped, a bucket number, N, the relative sizes, |L₁|, |L₂|, |L₃|, of the hash table levels, and/or any other suitable criteria.

Because the 16 write operations across the buckets 410.0, . . . , 410.15 at L₂ 404 cause 16 new entries to be written to each bucket 410.0, . . . , 410.15, the hardening of new entries contained in the bucket 408 at L₁ 402 is repeated R₂ (i.e., 16; see equation (4)) times to fill each bucket 410.0, . . . , 410.15 at L₂ 404 to the specified fullness threshold, B (i.e., 256; see equation (6)). As a result, the total number of new entries (“#NewEntries”) hardened to the buckets 410.0, . . . , 410.15 at L₂ 404 can be determined, as follows:

$$\# NewEntries = {R}_{2} * B \qquad ( 7 )$$

$$\# NewEntries = 16 * 256 = 4 , 096 \qquad ( 8 )$$

In addition, the number of required write operations (“#L2Writes”) to the buckets 410.0, 410.1, . . . , 410.15 at L₂ 404 can be determined, as follows:

$$\# {L}_{2} Writes = {R}_{2}^{2} \qquad ( 9 )$$

$$\# {L}_{2} Writes = {16}^{2} = 256 \qquad ( 10 )$$

Because at least some of the buckets 412.0, . . . , 412.255 at L₃ 406 may contain valid index entries, any unwanted overwriting of valid index entries when hardening new entries contained in the buckets 410.0, . . . , 410.15 at L₂ 404 is avoided by copying index entries from L₃ 406 to the RAM buffer 116, and merging the new entries from L₂ 404 with the index entries from L₃ 406 in the RAM buffer 116. For example, such copying of index entries from L₃ 406 to the RAM buffer 116 and subsequent merging with new entries from L₂ 404 may be performed in a cyclic fashion on subsets of the buckets 412.0, . . . , 412.255 at L₃ 406. Having merged the new entries from L₂ 404 with the index entries from L₁ 406 in the RAM buffer 116, the merged index entries are written (i.e., hardened) across the buckets 412.0, . . . , 412.255 at L₃ 406, thereby requiring R₃ (i.e., 256; see equation (5)) write operations (“#L3Writes”) to the buckets 412.0, . . . , 412.255 at L₃ 406. FIG. 4 depicts, in simplified conceptual fashion, the hardening of the bucket 410.0 at L₂ 404 across the buckets 412.0, . . . , 412.255 at L₃ 406.

Taking the ratio of #NewEntries (i.e., 4,096) to the sum of #L2Writes (i.e., 256) and #L3Writes (i.e., 256), the amortization for hardening the new entries can be determined, as follows:

$$Amortization = \frac{\# NewEntries}{\# {L}_{2} Writes + \# {L}_{3} Writes} = \frac{{R}_{2} * B}{{R}_{2}^{2} + {R}_{3}} \qquad ( 11 )$$

$$Amortization = \frac{16 * 256}{1 {6}^{2} + 256} = \frac{4 , 096}{256 + 256} = \frac{4 , 096}{512} = 8 \qquad ( 12 )$$

In this first example, the size, |L₂|, of the intermediate on-drive hash table level L₂ 404 for optimal amortization can be determined by taking the derivative of equation (11) with respect to R₂ (assuming |L₁|, |L₃|, and B are constants), and equating the result to zero (0), as follows:

$$\frac{d}{d {R}_{2}} ( \frac{{R}_{2} * B}{{R}_{2}^{2} + {R}_{3}} ) = \frac{B * ( {R}_{3} - {R}_{2}^{2} )}{{( {R}_{2}^{2} + {R}_{3} )}^{2}} = 0 \qquad ( 13 )$$

$${R}_{3} - {R}_{2}^{2} = 0 \qquad ( 14 )$$

$${R}_{2} = \sqrt{{R}_{3}} \qquad ( 15 )$$

$$\frac{\vert {L}_{2} \vert}{\vert {L}_{1} \vert} = \sqrt{\frac{\vert {L}_{3} \vert}{\vert {L}_{1} \vert}} \qquad ( 16 )$$

$$\vert {L}_{2} \vert = \sqrt{\vert {L}_{1} \vert \vert {L}_{3} \vert} \qquad ( 17 )$$

$$\vert {L}_{2} \vert = \sqrt{1 * 256} = 16 \qquad ( 18 )$$

In a second example, the disclosed technique is described with reference to a multilevel hash table encompassing an in-memory hash table level L₁ 502, an on-drive hash table level L₃ 506, and an intermediate on-drive hash table level L₂ 504 between L₁ 502 and L₃ 506 (see FIGS. 5a-5d). In this second example, the in-memory hash table level L₁ 502 has a size, |L₁|, defined by a single bucket 508, and the on-drive hash table level L₃ 506 has a size, |L₃|, defined by 256 buckets 512.0, 512.1, 512.2, . . . , 512.255 (see FIG. 5d). As such, the size, |L₃|, of the on-drive hash table level L₃ 506 is 256 times larger than the size, |L₁|, of the in-memory hash table level L₁ 502. The in-memory hash table level L₁ 502 is maintained in fast memory (e.g., RAM), and functions as a cache for the most frequently accessed (or most recently used) index entries. Further, the on-drive hash table level L₃ 506 is maintained on a storage drive (e.g., SSD), and configured to accommodate the bulk of index entries for the multi-level hash table. For example, the on-drive hash table level L₃ 506 may be accessed if a requested index entry is not found in either the in-memory hash table level L₁ 502 or the intermediate on-drive hash table level L₂ 504.

Unlike the intermediate on-drive hash table level L₂ 404 (see FIG. 4) described herein with reference to the first example, the intermediate on-drive hash table level L₂ 504 (see FIGS. 5a-5d) does not have a fixed size, but rather has a size, |L₂|, that is dynamically expandable, in successive hardening cycles, from an initial size to a final size. In this second example, the initial size is defined by a single initial bucket 510.0 (see FIG. 5a). Further, in successive cycles for hardening the bucket 508 at L₁ 502, the size, |L₂|, of the intermediate on-drive hash table level L₂ 504 is dynamically expanded from the initial size to the final size, in accordance with an arithmetic series. It is noted that once the buckets at L₂ 504 are hardened to the on-drive hash table level L₃ 506, the size of the intermediate on-drive hash table level L₂ is reset from the final size to the initial size. It is further noted that, as in the first example, the fullness threshold, B, for each bucket at each hash table level L₁, 502, L₂ 504, L₃ 506 is specified as 256 index entries (rounded to the closest native page size (e.g., 4 KB)).

FIG. 5a depicts, in a first hardening cycle, the hardening of the bucket 508 at L₁ 502 to the intermediate on-drive hash table level L₂ 504, which has the initial size, |L₂|, defined by the single initial bucket 510.0. In response to the bucket 508 at L₁ 502 reaching the specified fullness threshold, B (i.e., 256 index entries), new index entries contained in the bucket 508 are hardened to the bucket 510.0 at L₂ 504, thereby requiring one (1) write operation to the bucket 510.0. The new entries are then deleted or removed from the bucket 508 at L₁ 502.

FIG. 5b depicts a second cycle for hardening the bucket 508 at L₁ 502 to the intermediate on-drive hash table level L₂ 504. As shown in FIG. 5b, in the second hardening cycle, the intermediate on-drive hash table level L₂ 504 has a size, |L₂|, defined by the two (2) buckets 510.0, 510.1. In response to the bucket 508 at L₁ 502 reaching the specified fullness threshold, B (i.e., 256 index entries), new index entries contained in the bucket 508 are hardened across the buckets 510.0, 510.1 at L₂ 504. To avoid unwanted overwriting of valid index entries contained in at least the bucket 510.0 at L₂ 504 when hardening the bucket 508 at L₁ 502, index entries from L₂ 504 are copied to the RAM buffer 116, and the new entries from L₁ 502 are merged with the index entries from L₂ 504 in the RAM buffer 116. Having merged the new entries from L₁ 502 with the index entries from L₂ 504 in the RAM buffer 116, the merged index entries are written (i.e., hardened) across the buckets 510.0, 510.1 at L₂ 504, thereby requiring two (2) write operations to the buckets 510.0, 510.1. The new entries are then deleted or removed from the bucket 508 at L₁ 502. FIG. 5b depicts, in simplified conceptual fashion, the hardening of the bucket 508 at L₁ 502 across the two (2) buckets 510.0, 510.1 at L₂ 504.

FIG. 5c depicts a third cycle for hardening the bucket 508 at L₁ 502 to the intermediate on-drive hash table level L₂ 504. As shown in FIG. 5c, in the third hardening cycle, the intermediate on-drive hash table level L₂ 504 has a size, |L₂|, defined by the three (3) buckets 510.0, 510.1, 510.2. In response to the bucket 508 at L₁ 502 reaching the specified fullness threshold, B (i.e., 256 index entries), new index entries contained in the bucket 508 are hardened to the buckets 510.0, 510.1, 510.2 at L₂ 504. To avoid unwanted overwriting of valid index entries contained in at least the buckets 510.0, 510.1 at L₂ 504 when hardening the bucket 508 at L₁ 502, index entries from L₂ 504 are copied to the RAM buffer 116, and the new entries from L₁ 502 are merged with the index entries from L₂ 504 in the RAM buffer 116. Having merged the new entries from L₁ 502 with the index entries from L₂ 504 in the RAM buffer 116, the merged index entries are written (i.e., hardened) across the buckets 510.0, 510.1, 510.2 at L₂ 504, thereby requiring three (3) write operations to the buckets 510.0, 510.1, 510.2 at L₂ 504. The new entries are then deleted or removed from the bucket 508 at L₁ 502. FIG. 5c depicts, in simplified conceptual fashion, the hardening of the bucket 508 at L₁ 502 across the three (3) buckets 510.0, 510.1, 510.2 at L₂ 504.

In this second example, the hardening of new entries contained in the bucket 508 at L₁ 502 continues such that, in successive hardening cycles, the size, |L₂|, of the intermediate on-drive hash table level L₂ 504 is dynamically expanded according to an arithmetic series, from the single or one (1) initial bucket 510.0, to the two (2) buckets 510.0, 510.1, to the three (3) buckets 510.0, 510.1, 510.2, and so on, up to and including a number of buckets at L₂ 504 defining the final size, |L₂|, of the intermediate on-drive hash table level L₂ 504. In this second example, the number of required write operations (“#L2Writes”) to the buckets at L₂ 504 can be determined, as follows:

$$\# {L}_{2} Writes = {\sum }_{k = 1}^{{R}_{2}} k = 1 + 2 + 3 + … + {R}_{2} = \frac{{R}_{2} ( {R}_{2} + 1 )}{2} = \frac{{R}_{2}^{2} + {R}_{2}}{2} \qquad ( 19 )$$

It is noted that the number of required write operations (“#L2Writes_{(second_example)}”) to L₂ 504 is reduced compared to the number of required write operations (“#L2Writes_{(first_example)}”) to L₂ 404 in the first example. Indeed, taking the ratio of #L2Writes_{(second_example)} (see equation (19)) to #L2Writes_{(first_example)} (see equation (9)), and taking the limit as R₂ goes to infinity (∞), the number of required write operations to L₂ 504 is reduced by half (i.e., 0.5), as follows:

$$\frac{\# {L}_{2} {Writes}_{( second \_ example )}}{\# {L}_{2} {Writes}_{( first \_ example )}} = \frac{{R}_{2}^{2} + {R}_{2}}{2} \div {R}_{2}^{2} = \frac{1}{2} + \frac{1}{2 \sqrt{{R}_{2}}} \qquad ( 20 )$$

$${lim}_{{R}_{2} \to ∞} \frac{\# {L}_{2} {Writes}_{( second \_ example )}}{\# {L}_{2} {Writes}_{( first \_ example )}} = {lim}_{{R}_{2} \to ∞} \frac{1}{2} + \frac{1}{2 \sqrt{{R}_{2}}} = 0.5 \qquad ( 21 )$$

Because at least some of the buckets 512.0, . . . , 512.255 at L 506 (see FIG. 5d) may contain valid index entries, any unwanted overwriting of valid index entries when hardening new entries contained in the buckets at L₂ 504 is avoided by copying index entries from L₃ 506 to the RAM buffer 116, and merging the new entries from L₂ 504 with the index entries from L₃ 506 in the RAM buffer 116. For example, such copying of index entries from L₃ 506 to the RAM buffer 116 and subsequent merging with new entries from L₂ 504 may be performed in a cyclic fashion on subsets of the buckets 512.0, . . . , 512.255 at L₃ 506. Having merged the new entries from L₂ 504 with the index entries from L₃ 506 in the RAM buffer 116, the merged index entries are written (i.e., hardened) across the buckets 512.0, . . . , 512.255 at L₃ 506, thereby requiring R₃ (i.e., 256; see equation (5)) write operations (“#L3Writes”) to the buckets 512.0, . . . , 512.255 at L₃ 506. FIG. 5d depicts, in simplified conceptual fashion, the hardening of the bucket 510.0 at L₂ 504 across the buckets 512.0, . . . , 512.255 at L₃ 506.

Taking the ratio of #NewEntries (i.e., R₂*B; see equation (7)) to the sum of #L2Writes (i.e., (R₂²+R₂)/2; see equation (19)) and #L3Writes (i.e., R₃; see equation (5)), the amortization for hardening the new entries can be determined, as follows:

$$Amortization = \frac{\# NewEntries}{\# {L}_{2} Writes + \# {L}_{3} Writes} = \frac{{R}_{2} * B}{\frac{{R}_{2}^{2} + {R}_{2}}{2} + {R}_{3}} = \frac{2 {R}_{2} * B}{{R}_{2}^{2} + {R}_{2} + 2 {R}_{3}} \qquad ( 22 )$$

In this second example, the final size, |L₂|, of the intermediate on-drive hash table level L₂ 504 for optimal amortization is determined by taking the derivative of equation (22) with respect to R₂ (assuming |L₁|, |L₃|, and B are constants), and equating the result to zero (0), as follows:

$$\frac{d}{{dR}_{2}} ( \frac{2 {R}_{2} * B}{{R}_{2}^{2} + {R}_{2} + 2 {R}_{3}} ) = B * \frac{2 {R}_{3} + {R}_{2} + {R}_{2}^{2} - {R}_{2} - 2 {R}_{2}^{2}}{{( {R}_{2}^{2} + {R}_{2} + 2 {R}_{3} )}^{2}} \qquad ( 23 )$$

$$B * \frac{2 {R}_{3} + {R}_{2} + {R}_{2}^{2} - {R}_{2} - 2 {R}_{2}^{2}}{{( {R}_{2}^{2} + {R}_{2} + 2 {R}_{3} )}^{2}} = 0 \qquad ( 24 )$$

$${R}_{2} = \sqrt{2 {R}_{3}} \qquad ( 25 )$$

$$\frac{\vert {L}_{2} \vert}{\vert {L}_{1} \vert} = \sqrt{2 \frac{\vert {L}_{3} \vert}{\vert {L}_{1} \vert}} \qquad ( 26 )$$

$$\vert {L}_{2} \vert = \sqrt{2 \vert {L}_{1} \vert \vert {L}_{3} \vert} \qquad ( 27 )$$

$$\vert {L}_{2} \vert = \sqrt{2 * 1 * 256} ≅ 22 \qquad ( 28 )$$

Using the final size (i.e., 22; see equation (28)) of the intermediate on-drive hash table level L₂ 504, the amortization for hardening the new entries can be determined, as follows:

$$Amortization = \frac{\# NewEntries}{\# {L}_{2} Writes + \# {L}_{3} Writes} = \frac{22 * 256}{\frac{{22}^{2} + 22}{2} + 256} ≅ 11 \qquad ( 29 )$$

As can be seen from equations (28) and (18), the final size of the intermediate on-drive hash table level L₂ 504 for optimal amortization is increased by a factor of \sqrt{2}(i.e., from 16 buckets to 22 buckets) compared to the prior technique. In addition, as can be seen from equations (29) and (12), the amortization for hardening new entries is improved by more than 30% (i.e., from 8 to 11) compared to the prior technique.

As employed herein, the term “amortization improvement” refers to the ratio of amortization obtained in this second example (“Amortization_{(second_example)}”) to the amortization obtained in the first example (“Amortization_{(first_example)}”). Using equation (25), an optimal Amortization_{(second_example)} can be expressed in terms of R₃, as follows:

$${Amortization}_{( second \_ example )} = \frac{2 {R}_{2} * B}{{R}_{2}^{2} + {R}_{2} + 2 {R}_{3}} = \frac{2 \sqrt{{R}_{3}} * B}{{( \sqrt{{R}_{3}} )}^{2} + \sqrt{{R}_{3}} + 2 {R}_{3}} \qquad ( 30 )$$

$${Amortization}_{( second \_ example )} = \frac{2 B}{3 \sqrt{{R}_{3}} + 1} \qquad ( 31 )$$

Likewise, using equation (15), an optimal Amortization_{(first_example)} can be expressed in terms of R₃, as follows:

$${Amortization}_{( first \_ example )} = \frac{{R}_{2} * B}{{R}_{2}^{2} + {R}_{3}} = \frac{\sqrt{{R}_{3}} * B}{{( \sqrt{{R}_{3}} )}^{2} + {R}_{3}} = \frac{B}{2 \sqrt{{R}_{3}}} \qquad ( 32 )$$

Taking the ratio of Amortization_{(second_example)} (see equation (31)) to Amortization_{(first_example)} (see equation (32)), the amortization improvement obtained in this second example can be determined, as follows:

$$\frac{{Amortization}_{( second \_ example )}}{{Amortization}_{( first \_ example )}} = \frac{\frac{2 B}{3 \sqrt{{R}_{3}} + 1}}{\frac{B}{2 \sqrt{{R}_{3}}}} = \frac{4 \sqrt{{R}_{3}}}{3 \sqrt{{R}_{3}} + 1} \qquad ( 33 )$$

Taking the limit as R₃ goes to infinity (∞), a maximum amortization improvement (%) can be determined, as follows:

$${lim}_{{R}_{3} \to ∞} \frac{{Amortization}_{( second \_ example )}}{{Amortization}_{( first \_ example )}} = {lim}_{{R}_{3} \to ∞} \frac{4 \sqrt{{R}_{3}}}{3 \sqrt{{R}_{3}} + 1} \qquad ( 34 )$$

$${lim}_{{R}_{3} \to ∞} \frac{{Amortization}_{( second \_ example )}}{{Amortization}_{( first \_ example )}} = {lim}_{{R}_{3} \to ∞} \frac{4}{3 + \frac{1}{\sqrt{{R}_{3}}}} = \frac{4}{3} = 1.33 ( 33 \% ) \qquad ( 35 )$$

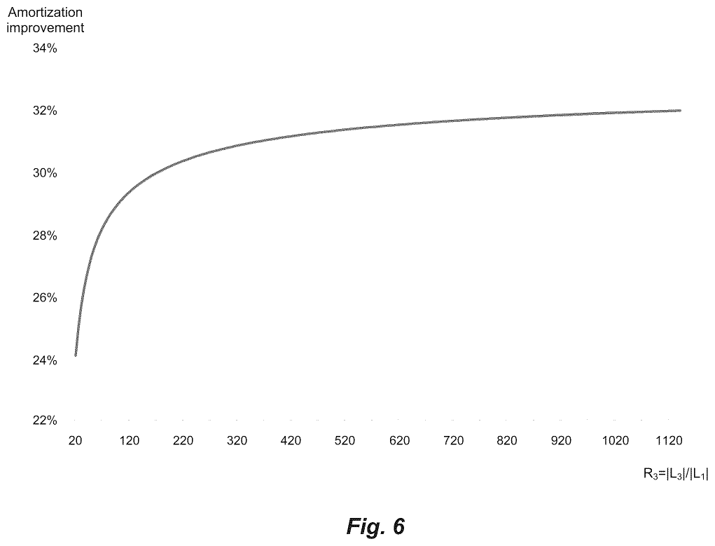

FIG. 6 is a diagram of the amortization improvement (%) that can be obtained relative to R₃ (i.e., the ratio of the size, |L₃|, of the on-drive hash table level L₃ 506 to the size, |L₁|, of the in-memory hash table level L₁ 502). As shown in FIG. 6, as R3 increases over a range of about 20 to 1120, the amortization improvement (%) increases from about 24% toward the maximum amortization improvement of 33% (see also equation (35)).

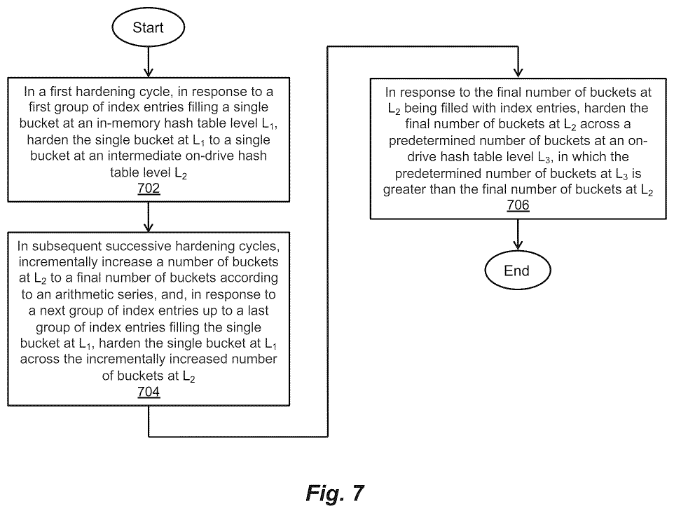

A method of improving amortization when hardening index entries across a multilevel hash table is described below with reference to FIG. 7. As depicted in block 702, in a first hardening cycle, in response to a first group of index entries filling a single bucket at an in-memory hash table level L₁, the single bucket at L₁ is hardened to a single bucket at an intermediate on-drive hash table level L₂. As depicted in block 704, in subsequent successive hardening cycles, a number of buckets at L₂ is incrementally increased to a final number of buckets according to an arithmetic series, and, in response to a next group of index entries up to a last group of index entries filling the single bucket at L₁, the single bucket at L₁ is hardened across the incrementally increased number of buckets at L₂. As depicted in block 706, in response to the final number of buckets at L₂ being filled with index entries, the final number of buckets at L₂ are hardened across a predetermined number of buckets at an on-drive hash table level L₃, in which the predetermined number of buckets at L₃ is greater than the final number of buckets at L₂.

Several definitions of terms are provided below for the purpose of aiding the understanding of the foregoing description, as well as the claims set forth herein.

As employed herein, the term “storage system” is intended to be broadly construed to encompass, for example, private or public cloud computing systems for storing data, as well as systems for storing data comprising virtual infrastructure and those not comprising virtual infrastructure.

As employed herein, the terms “client”, “host”, and “user” refer, interchangeably, to any person, system, or other entity that uses a storage system to read/write data.

As employed herein, the term “storage device” may refer to a storage array including multiple storage devices. Such storage devices may refer to any non-volatile memory (NVM) devices, including hard disk drives (HDDs), solid state drives (SSDs), flash devices (e.g., NAND flash devices, NOR flash devices), and/or similar devices that may be accessed locally and/or remotely, such as via a storage area network (SAN).

As employed herein, the term “storage array” may refer to a storage system used for page-based, block-based, file-based, or other object-based storage. Such a storage array may include, for example, dedicated storage hardware containing HDDs, SSDs, and/or all-flash drives.

As employed herein, the term “storage entity” may refer to a filesystem, an object storage, a virtualized device, a logical unit (LU), a logical volume (LV), a logical device, a physical device, and/or a storage medium.

As employed herein, the term “LU” may refer to a logical entity provided by a storage system for accessing data from the storage system and may be used interchangeably with a logical volume (LV). The term “LU” may also refer to a logical unit number (LUN) for identifying a logical unit, a virtual disk, or a virtual LUN.

As employed herein, the term “physical storage unit” may refer to a physical entity such as a storage drive or disk or an array of storage drives or disks for storing data in storage locations accessible at addresses. The term “physical storage unit” may be used interchangeably with the term “physical volume”.

As employed herein, the term “storage medium” may refer to a hard drive or flash storage, a combination of hard drives and flash storage, a combination of hard drives, flash storage, and other storage drives or devices, or any other suitable types and/or combinations of computer readable storage media. Such a storage medium may include physical and logical storage media, multiple levels of virtual-to-physical mappings, and/or disk images. The term “storage medium” may also refer to a computer-readable program medium.

As employed herein, the term “IO request” or “IO” may refer to a data input or output request such as a write request or a read request.

As employed herein, the terms, “such as”, “for example”, “e.g.”, “exemplary”, and variants thereof refer to non-limiting embodiments and have meanings of serving as examples, instances, or illustrations. Any embodiments described herein using such phrases and/or variants are not necessarily to be construed as preferred or more advantageous over other embodiments, and/or to exclude incorporation of features from other embodiments.

As employed herein, the term “optionally” has a meaning that a feature, element, process, etc., may be provided in certain embodiments and may not be provided in certain other embodiments. Any particular embodiment of the present disclosure may include a plurality of optional features unless such features conflict with one another.

While various embodiments of the present disclosure have been particularly shown and described, it will be understood by those skilled in the art that various changes in form and details may be made therein without departing from the scope of the present disclosure, as defined by the appended claims.

What is claimed is:

1. A method comprising:
in a first hardening cycle, in response to a first group of index entries filling a single bucket data structure (“bucket”) at an in-memory hash table level (“L₁”), hardening the single bucket at L₁ to a single initial bucket at an intermediate on-drive hash table level (“L₂”);
in subsequent successive hardening cycles:
incrementally increasing a number of buckets at L₂ to a final number of buckets according to an arithmetic series; and
in response to a next group of index entries up to a last group of index entries filling the single bucket at L₁, hardening the single bucket at L₁ across the incrementally increased number of buckets at L₂; and
in response to the final number of buckets at L₂ being filled with index entries, hardening the final number of buckets at L₂ across a predetermined number of buckets at an on-drive hash table level (“L₃”), the predetermined number of buckets at L₃ being greater than the final number of buckets at L₂.

2. The method of claim 1 comprising:
in the first hardening cycle, having hardened the single bucket at L₁ to the single initial bucket at L₂, deleting or removing the first group of index entries from the single bucket at L₁.

3. The method of claim 2 comprising:
in the subsequent successive hardening cycles, having hardened the single bucket at L₁ across the incrementally increased number of buckets at L₂, deleting or removing the next group of index entries up to the last group of index entries from the single bucket at L₁.

4. The method of claim 1 comprising:
having hardened the final number of buckets at L₂ across the predetermined number of buckets at L₃, resetting the number of buckets at L₂ to an initial number defined by a single bucket.

5. The method of claim 1 wherein “|L₁|” denotes a size of L₁ in terms of a first number of buckets, wherein “|L₂|” denotes a size of L₂ in terms of the final number of buckets, wherein “|L₃|” denotes a size of L₃ in terms of the predetermined number of buckets, and wherein the incrementally increasing of the number of buckets at L₂ to the final number of buckets according to an arithmetic series includes incrementally increasing the size of L₂ to |L₂| expressed as:
$$\vert {L}_{2} \vert = \sqrt{2 \vert {L}_{1} \vert \vert {L}_{3} \vert .}$$

6. The method of claim 5 wherein “R₂” denotes a ratio of |L₂| to |L₁|, wherein “R₃” denotes a ratio of |L₃| to |L₁|, wherein “B” denotes a fullness threshold for each bucket at L₁, L₂, and L₃ in terms of a predetermined number of index entries, and wherein the method comprises:
determining an amortization for hardening the final number of buckets at L₂ across the predetermined number of buckets at L₃,
wherein the amortization is expressed as:
$$Amortization = \frac{2 {R}_{2} * B}{{R}_{2}^{2} + {R}_{2} + 2 {R}_{3}} .$$

7. The method of claim 6 wherein the incrementally increasing of the number of buckets at L₂ to the final number of buckets according to the arithmetic series includes incrementally increasing the number of buckets at L₂ to the final number of buckets according to the arithmetic series expressed as:
$${\sum }_{k = 1}^{{R}_{2}} k = 1 + 2 + 3 + … + {R}_{2} = \frac{{R}_{2} ( {R}_{2} + 1 )}{2} = \frac{{R}_{2}^{2} + {R}_{2}}{2} .$$

8. A system comprising:
a memory; and
processing circuitry configured to execute program instructions out of the memory to:
in a first hardening cycle, in response to a first group of index entries filling a single bucket data structure (“bucket”) at an in-memory hash table level (“L₁”), harden the single bucket at L₁ to a single initial bucket at an intermediate on-drive hash table level (“L₂”);
in subsequent successive hardening cycles:
incrementally increase a number of buckets at L₂ to a final number of buckets according to an arithmetic series; and
in response to a next group of index entries up to a last group of index entries filling the single bucket at L₁, harden the single bucket at L₁ across the incrementally increased number of buckets at L₂; and
in response to the final number of buckets at L₂ being filled with index entries, harden the final number of buckets at L₂ across a predetermined number of buckets at an on-drive hash table level (“L₃”), wherein the predetermined number of buckets at L₃ is greater than the final number of buckets at L₂.

9. The system of claim 8 wherein the processing circuitry is configured to execute the program instructions out of the memory, in the first hardening cycle, having hardened the single bucket at L₁ to the single initial bucket at L₂, to delete or remove the first group of index entries from the single bucket at L₁.

10. The system of claim 9 wherein the processing circuitry is configured to execute the program instructions out of the memory, in the subsequent successive hardening cycles, having hardened the single bucket at L₁ across the incrementally increased number of buckets at L₂, to delete or remove the next group of index entries up to the last group of index entries from the single bucket at L₁.

11. The system of claim 8 wherein the processing circuitry is configured to execute the program instructions out of the memory, having hardened the final number of buckets at L₂ across the predetermined number of buckets at L₃, to reset the number of buckets at L₂ to an initial number defined by a single bucket.

12. The system of claim 8 wherein “|L₁|” denotes a size of L₁ in terms of a first number of buckets, wherein “|L₂|” denotes a size of L₂ in terms of the final number of buckets, wherein “|L₃|” denotes a size of L₃ in terms of the predetermined number of buckets, and wherein the processing circuitry is configured to execute the program instructions out of the memory to incrementally increase the size of L₂ to |L₂| expressed as:
$$\vert {L}_{2} \vert = \sqrt{2 \vert {L}_{1} \vert \vert {L}_{3} \vert .}$$

13. The system of claim 12 wherein “R₂” denotes a ratio of |L₂| to |L₁|, wherein “R₃” denotes a ratio of |L₃| to |L₁|, wherein “B” denotes a fullness threshold for each bucket at L₁, L₂, and L₃ in terms of a predetermined number of index entries, and wherein the processing circuitry is configured to execute the program instructions out of the memory to:
determine an amortization for hardening the final number of buckets at L₂ across the predetermined number of buckets at L₃,
wherein the amortization is expressed as:
$$Amortization = \frac{2 {R}_{2} * B}{{R}_{2}^{2} + {R}_{2} + 2 {R}_{3}} .$$

14. The system of claim 13 wherein the processing circuitry is configured to execute the program instructions out of the memory to incrementally increase the number of buckets at L₂ to the final number of buckets according to the arithmetic series expressed as:
$${\sum }_{k = 1}^{{R}_{2}} k = 1 + 2 + 3 + … + {R}_{2} = \frac{{R}_{2} ( {R}_{2} + 1 )}{2} = \frac{{R}_{2}^{2} + {R}_{2}}{2} .$$

15. A computer program product including a set of non-transitory, computer-readable media having program instructions that, when executed by processing circuitry, cause the processing circuitry to perform a method comprising:
in a first hardening cycle, in response to a first group of index entries filling a single bucket data structure (“bucket”) at an in-memory hash table level (“L₁”), hardening the single bucket at L₁ to a single initial bucket at an intermediate on-drive hash table level (“L₂”);
in subsequent successive hardening cycles:
incrementally increasing a number of buckets at L₂ to a final number of buckets according to an arithmetic series; and
in response to a next group of index entries up to a last group of index entries filling the single bucket at L₁, hardening the single bucket at L₁ across the incrementally increased number of buckets at L₂; and
in response to the final number of buckets at L₂ being filled with index entries, hardening the final number of buckets at L₂ across a predetermined number of buckets at an on-drive hash table level (“L₃”), the predetermined number of buckets at L₃ being greater than the final number of buckets at L₂.

16. The computer program product of claim 15 wherein the method comprises:
in the first hardening cycle, having hardened the single bucket at L₁ to the single initial bucket at L₂, deleting or removing the first group of index entries from the single bucket at L₁.

17. The computer program product of claim 16 wherein the method comprises:
in the subsequent successive hardening cycles, having hardened the single bucket at L₁ across the incrementally increased number of buckets at L₂, deleting or removing the next group of index entries up to the last group of index entries from the single bucket at L₁.

18. The computer program product of claim 15 wherein the method comprises:
having hardened the final number of buckets at L₂ across the predetermined number of buckets at L₃, resetting the number of buckets at L₂ to an initial number defined by a single bucket.

19. The computer program product of claim 15 wherein “|L₁|” denotes a size of L₁ in terms of a first number of buckets, wherein “|L₂|” denotes a size of L₂ in terms of the final number of buckets, wherein “|L₃|” denotes a size of L₃ in terms of the predetermined number of buckets, and wherein the incrementally increasing of the number of buckets at L₂ to the final number of buckets according to an arithmetic series includes incrementally increasing the size of L₂ to |L₂| expressed as:
$$\vert {L}_{2} \vert = \sqrt{2 \vert {L}_{1} \vert \vert {L}_{3} \vert .}$$

20. The computer program product of claim 19 wherein “R₂” denotes a ratio of |L₂| to |L₁|, wherein “R₃” denotes a ratio of |L₃| to |L₁|, wherein “B” denotes a fullness threshold for each bucket at L₁, L₂, and L₃ in terms of a predetermined number of index entries, and wherein the method comprises:
determining an amortization for hardening the final number of buckets at L₂ across the predetermined number of buckets at L₃,
wherein the amortization is expressed as:
$$Amortization = \frac{2 {R}_{2} * B}{{R}_{2}^{2} + {R}_{2} + 2 {R}_{3}} .$$
